(19) United States
(12) Patent Application Publication
(10) Pub. No.: US 2021/0212310 A1
(43) Pub. Date: Jul. 15, 2021

(54) MULTI-LURED WILDLIFE ATTRACTING CARTRIDGE

(71) Applicant: Joey Daniel Wells, Greeneville, AL (US)

(72) Inventor: Joey Daniel Wells, Greeneville, AL (US)

(21) Appl. No.: 16/742,403

(22) Filed: Jan. 14, 2020

(51) Int. Cl. A01M 31/00; F42B 12/50

(52) U.S. Cl. CPC A01M 31/008; F42B 12/50

(57) ABSTRACT

A device for attracting wildlife is provided. The device generally comprises a shell having a plurality of compartments and at least one wildlife attractant. The shell may be rigid, soft, or a combination thereof. In some embodiments of the device, a bung may be used to allow a user to fill the compartments with a wildlife attractant of their choice. The combination of wildlife attractants used in the device may entice and/or ward wildlife to a particular area of an environment.

### FIELD OF THE DISCLOSURE

The subject matter of the present disclosure refers generally to a device having multiple lures that may be used to attract wildlife.

### BACKGROUND

Lures are often used to attract wildlife to a hunter's location. The chemicals within the lures naturally draw the animals into the hunter's trap without the animal being any wiser. In the past, attractant has typically been distributed in liquid form by manner of pouring the attractant onto an absorbent pad and hanging that saturated pad at an elevated point. Another method of distributing the attractant involves a hunter dragging a rag behind them as they inspect an area, which may also have the added benefit of masking the hunter's scent. However, despite the steps a hunter may take to hide their scent, it is often not enough. The only true way for a hunter to prevent their scent from contaminating an area is to never set foot in that area.

Additionally, there are many types of lures that hunters use to attract their prey. Certain types of lures mimic pheromones and/or hormones that cause an animals mating instinct to be peeked. Other types of lures mimic food sources that the animals eat, which causes animals feeding instincts to take over. Other lures simply alert animals that something worth investigating is going on in a particular area and/or mask a hunter's scent. Currently, there is no way a hunter may mix and match lures in a way custom to the needs of the hunter. Nor is there a device that a hunter can use to hold those attractants so that they can be distributed at a long range to prevent the hunter's scent from contaminating an area.

Accordingly, there is a need in the art for a cartridge having multiple lures that may be used to attract wildlife at range.

### DESCRIPTION

A system and method for distributing wildlife attractant is provided. In one aspect, the system and method allow a user to distribute wildlife attractant from range in order to reduce the amount of the user's scent that contaminates an area. In another aspect, the system and method allow a user to distribute multiple animal attractants to an area using a single device. In yet another aspect, the system and method allow a user to create customized cartridges having multiple wildlife attractants so a user may create cartridges more specific to their needs. Generally, the system and method of the present disclosure is designed to allow a user to distribute multiple animal attractants at range. The system generally comprises a shell having a plurality of compartments and at least one wildlife attractant. The various method steps associated with the methods of the present disclosure may be carried out by a user using the system disclosed herein.

The cartridge may be made using a rigid material, soft material, or a combination thereof. The cartridge may comprise a plurality of compartments that are fully or partially surrounded by subsequent compartments. This may allow a user to launch a cartridge having multiple wildlife attractants into an environment for different effects. In a preferred embodiment, the soft material is a polyvinyl acetate film. The PVA film is preferably thick enough to allow a user to handle but thin enough to break upon impact with a target. The cartridge may further comprise at least one bung for filling the plurality of compartments. The compartments may be filled by a user via the at least one bung by way of a syringe.

The wildlife attractant may be in liquid, powder, solid, and gel form, but other forms are acceptable so long as those forms may be contained within the at least one compartments of the cartridge. Alternatively, a biodegradable polymer material may be impregnated with the wildlife attractant in a way such that as the polymer degrades, the wildlife attract is released into the environment over time. Types of lures that may be used as wildlife attractant include, but are not limited to, gland lures, food lures, and call lures, or any combination thereof. In a preferred embodiment, the user may launch the cartridges into an environment using a distribution tool, which may allow the user to target specific areas within an environment with more accuracy and reduce the amount of scent transferred from the user to the cartridge.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other methods for carrying out the same purpose of the methods disclosed herein. Those skilled in the pertinent art should also realize that such equivalent modifications do not depart from the scope of the methods of the present disclosure.

### DESCRIPTION OF THE DRAWINGS

These and other features, aspects, and advantages of the present disclosure will become better understood with regard to the following description, appended claims, and accompanying drawings where:

FIG. 1 is an illustration of a device having features consistent with the invention of the present disclosure.

FIG. 2 is an illustration of a device having features consistent with the invention of the present disclosure.

FIG. 3 is an illustration of a device being used within an environment to attract wildlife to a user's location.

FIG. 4 is an illustration of a device being used within an environment to attract wildlife to a user's location.

FIG. 5 is a flow chart illustrating certain method steps of a method embodying features consistent with the principles of the present disclosure.

FIG. 6 is a flow chart illustrating certain method steps of a method embodying features consistent with the principles of the present disclosure.

### DETAILED DESCRIPTION

In this Detailed Description, and the Claims below, and in the accompanying drawings, reference is made to particular features, including process steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally. Where reference is made herein to a process comprising two or more defined steps, the defined steps can be carried out in any order or simultaneously (except where the context excludes that possibility), and the process can include one or more other steps which are carried out before any of the defined steps, between two of the defined steps, or after all the defined steps (except where the context excludes that possibility).

The term “comprises” and grammatical equivalents thereof are used herein to mean that other components, steps, etc. are optionally present. For instance, a system “comprising” components A, B, and C can contain only components A, B, and C, or can contain not only components A, B, and C, but also one or more other components. The term “at least one of . . . and” and grammatical equivalents thereof are used herein to mean that at least one of a group of items is present but more components of that group can be present. For instance, a system comprising at least one of components A, B, and C can contain only components A and B, or can contain multiple components A and C, but only one of component B. As used herein, the term “at least one” and grammatical equivalents thereof are used herein to mean that one or more of an item is present. For instance, at least one magnet means that an embodiment exists with a single magnet as well embodiments with multiple magnets.

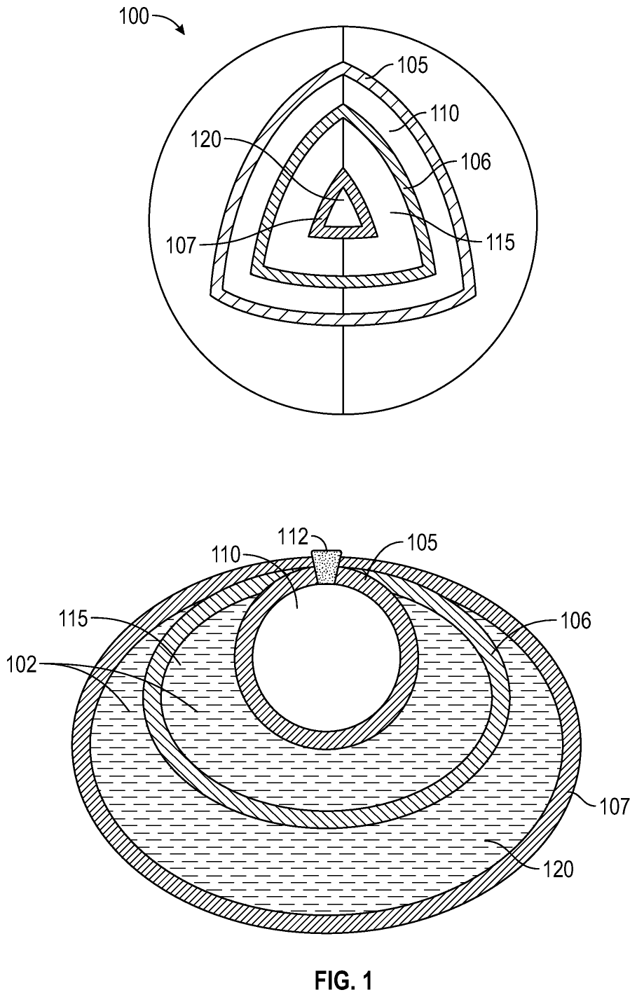

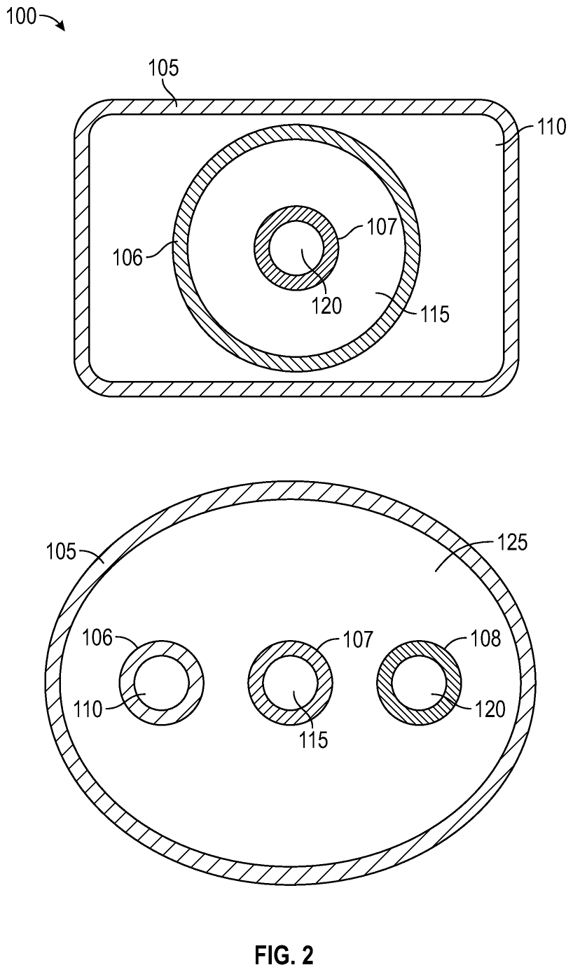

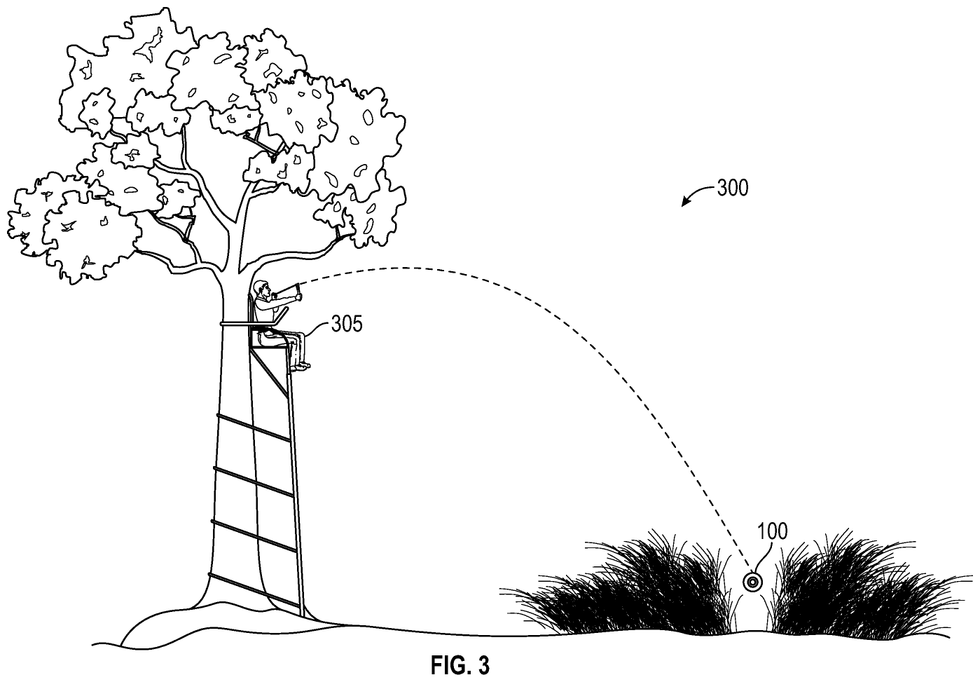

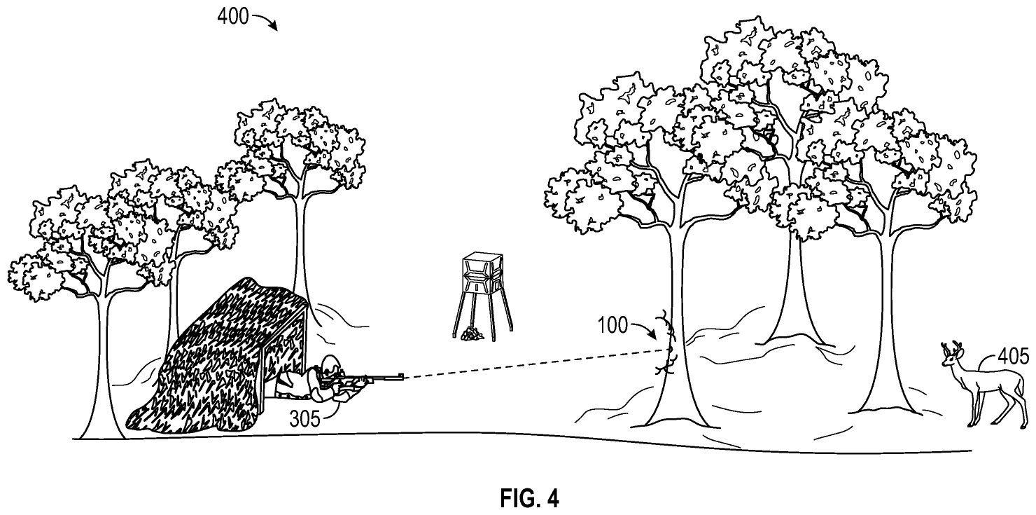

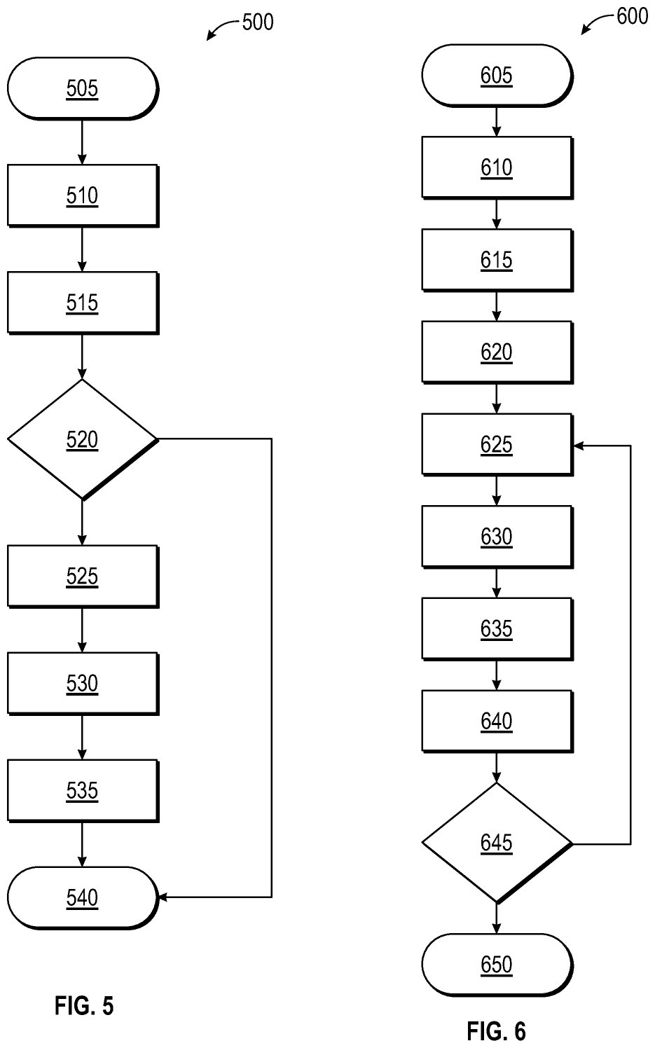

FIGS. 1-6 illustrate embodiments of a device 100 having multiple lures that may be used to attract wildlife 405 as well as associated methods. It is understood that the various method steps associated with the methods of the present disclosure may be carried out by a user 305 using the device 100 shown in FIGS. 1-4. The system generally comprises a shell 105, 106, 107, 108 having a plurality of compartments 110, 115, 120, 125 designed to hold at least one wildlife attractant 102. As illustrated in FIGS. 1-2, the shell 105, 106, 107, 108 may be constructed of a rigid material or a soft material and may have any number of compartments arranged in a number of ways that hold the at least one attractant. FIG. 1 illustrates embodiments of devices 100 comprising a central first compartment 110 completely surrounded by additional compartments and cross-sectional view of a device having a bung. FIG. 2 illustrates cross-sectional views of devices 100 comprising compartments that are only partially surrounded by other compartments. FIGS. 3 and 4 illustrate how a user 305 might use the device 100 in an environment 300, 400. FIGS. 5 and 6 illustrate methods that may be carried out by a user 305 using the device 100.

In one preferred embodiment, the shell 105, 106, 107, 108 of a device 100 may made using a rigid material. In a preferred embodiment, the rigid material is biodegradable such that the device 100 may degrade over time and release the at least one wildlife attractant 102. In another preferred embodiment, a shell 105, 106, 107, 108 comprising a rigid material may be constructed in a way such that it breaks upon contact with a target. For instance, the shell 105, 106, 107, 108 of a device 100 shot by a user 305 via a sling shot may break upon contacting a desired target, causing the wildlife attractant 102 within the plurality of compartments 110, 115, 120, 125 of the device 100 to be released into an environment 300, 400. For instance, a device 100 thrown by a user 305 into a field may break upon contact with the ground, thus releasing the wildlife attractant 102 into said field. Alternatively, the shell 105, 106, 107, 108 of a device 100 may be made using a soft material. In a preferred embodiment, the soft material is a polyvinyl acetate (PVA) film. The PVA film is preferably thick enough to allow a user 305 to handle but thin enough to break upon impact with a target. For instance, a device 100 impacted against a tree in a wooded area, as illustrated in FIG. 4, may cause the soft-shell of the device 100 to break, causing the wildlife attractant 102 within the device 100 to be released into the environment 300, 400. For instance, crushing a device 100 onto a hunter's tree stand to mask the hunter's scent may cause the wildlife attractant 102 to distribute over said tree stand.

In another preferred embodiment, the shell 105, 106, 107, 108 of a device 100 may comprise of both a rigid material and a soft material. For instance, the device depicted at the bottom of FIG. 1 may have an outer first shell 105 and inner second shell 106 constructed of a PVA film and an inner third shell 107 constructed of a hard, biodegradable material. A device constructed in this way may allow a user 305 to launch said device 100 into an environment 300, 400 via a sling, causing the PVA film of the outer first shell 105 and inner second shell 106 to break upon impact and immediately release the wildlife attractant 102 of the third compartment 120 and second compartment 115 into the environment 300, 400. However, the wildlife attractant 102 in the first compartment 110, surrounded by the hard, biodegradable material of the inner third shell 107, may be released over time as the biodegradable material decomposes. For instance, the device depicted at the top of FIG. 1 may have an outer first shell 105 constructed of a rigid material designed to withstand the force of being fired from an air gun. The inner second shell 106 and inner third shell 107 of the device 100 may be constructed of a soft material designed to break upon impact with a target. This may allow a user 305 to fire the device 100 from an air gun and release the animal attractant into an environment 300, 400 after impact with said target.

A device 100 may comprise a plurality of compartments 110, 115, 120, 125 that are fully encapsulated by subsequent compartments. As illustrated in FIG. 1, a first compartment 110 of the device 100 may surrounded by a second compartment 115, and the second compartment 115 may be completely surrounded by a third compartment 120. This may allow a user 305 to launch a device 100 having multiple wildlife attractants 102 into an environment 300, 400 for different effects. For instance, a device 100 having a first compartment 110 filled with doe urine surrounded by a second compartment 120 filled with apple extract might signal to a buck that both an apple tree and a doe in the middle of her estrous cycle are nearby. For instance, a device 100 having a first compartment 110 filled with clover extract, a second compartment 115 filled with corn extract, and a third compartment 120 filled with strawberry extract may signal to a wild hog that sustenance is the area.

Alternatively, a device 100 may comprise a plurality of compartments that are partially surrounded by subsequent compartments. As illustrated at the top of FIG. 2, a device 100 having a first compartment 110 located in the center of said device 100 may only be partially surrounded by a second compartment 115, and the second compartment 115 may be only partially surrounded by a third compartment 120. In one preferred embodiment, as illustrated at the bottom of FIG. 2, a device 100 may have a fourth compartment 125 that partially surrounds a first compartment 110, second compartment 115, and third compartment 120. By only partially surrounding the plurality of compartments 110, 115, 120, 125, a user 305 may more easily identify the wildlife attractants 102 within a particular device 100. Additionally, partially surrounding the plurality of compartments may allow easier customization by making it easier for a user 305 to access each individual compartment of a device 100. For instance, the device 100 depicted at the bottom of FIG. 2 may be configured in a way that grants a user 305 access to each compartment. This may allow a user 305 to choose which wildlife attractants 102 should go into a device 100.

In one preferred embodiment, as illustrated at the bottom of FIG. 1, a device 100 may further comprise at least one bung 112 that allows a user 305 to fill the plurality of compartments 110, 115, 120, 125 of a device 100. In a preferred embodiment, the plurality of compartments 110, 115, 120, 125 may be filled by a user 305 via the at least one bung 112 by way of a syringe. For instance, a device 100 may comprise a first compartment 110 filled with deer pheromones, a second compartment 115 filled with doe urine, and an empty third compartment 120 having at least one bung 112. A syringe may be used in a way such that a user 305 may inject the at least one device 100 with a wildlife attractant 102 of their choice via the at least one bung 112. The user 305 may plug the at least one bung 112 once the compartment has been filled with the desired animal attract, which prevents the wildlife attractant 102 from exiting the device 100 after injection. Alternatively, the at least one bung 112 may be self-sealing. For instance, a user 305 may inject a wildlife attractant 102 into the device 100 via a syringe through a self-sealing bung 112. Once the user 305 removes the syringe from the self-sealing bung 112, the self-sealing bung 112 may seal the hole created by the syringe, thus trapping the wildlife attractant 102 in the device 100.

The wildlife attractant 102 may be in liquid, solid, powder, and gel form. Alternatively, a biodegradable polymer material may be impregnated with the wildlife attractant 102 in a way such that as the polymer degrades, the wildlife attractant 102 is released into the environment 300, 400 over time. Types of wildlife attractant lures that may be used as wildlife attractant 102 include, but are not limited to, gland lures, food lures, and call lures, or any combination thereof. For instance, a device 100 may have a first compartment 110 filled with a gel-based gland lure and a second compartment 115 filled with a biodegradable polymer impregnated with said gel-based gland lure. A user 305 may place this device 100 in an environment 300, 400 so it releases the gland lure into the environment 300, 400 immediately via the gel and over time via the biodegradable polymer impregnated with the gland lure. For instance, a device 100 may have a first compartment 110 filled with a call lure, a second compartment 115 filled with a food lure, and a third compartment 120 filled with a gland lure. A user 305 may place this device 100 in an environment 300, 400 to instantly permeate said environment 300, 400 with scents that attract wild life to the area (call lure), stoke the wildlife's 405 feeding instinct (food lure), and excite the wildlife's 405 territorial instinct (gland lure). For instance, a device 100 may have a first compartment 110 filled with powdered blood (feed lure), a second compartment 115 filled with blackberry extract (feed lure), and a third compartment 120 filled with strawberry extract (feed lure). A user 305 may place this device 100 in an environment 300, 400 to instantly permeate said environment 300, 400 with scents that may signal to a grizzly beer that injured prey and sustenance is in the area.

As used herein, the term gland lure refers to natural or synthetic gland pheromones and hormones that may be used to attract wildlife 405 of the same species or predators/competitors of that species. For instance, doe urine acquired from a doe during their estrous cycle may be used to in an environment 300, 400 in order to attract males desiring to mate. For instance, red fox gland may be used to attract territorial bob cats, coyotes, and foxes. As used herein, the term call lure refers to natural or synthetic scents that attract an animal to an environment 300, 400, often form long distance. In one preferred embodiment, a call lure may mask undesirable scents that may cause wildlife 405 to shun a particular area. For instance, skunk essence may be used to both entice wildlife 405 to a particular environment 300, 400 and mask human scent that may otherwise drive the wildlife 405 away. As used herein, the food lure refers to attractant designed to appeal to wildlife's 405 feeding instinct. Types of food that food lures may mimic include, but are not limited to, fruit, vegetables, and meat. For instance, apple extract may be used to attract wildlife 405 that consume apples. For instance, corn extract may be used to attract wildlife 405 that consume corn. Fish oil may be used to attract wildlife 405 that consumes fish.

The device 100 may enter an environment 300, 400 via an applied force. In one preferred embodiment, as illustrated in FIG. 3, the device 100 may be distributed to an environment 300, 400 via force applied by a slingshot operated by a user 305. In another preferred embodiment, as illustrated in FIG. 4, the device 100 may be distributed into an environment 300, 400 via an air gun operated by the user 305. The user 305 may use multiple devices 100 or may use a single device 100, depending on the at least one wildlife attractant 102 within the devices 100 and the desired outcome of the user 305. For instance, a user 305 may have a plurality of devices 100 comprising skunk essence, gel-based synthetic doe urine, and a biodegradable polymer impregnated with synthetic doe urine that may be used to appeal to a buck's mating instinct. The user 305 may also have a plurality of devices 100 comprising blueberry extract, clover essential oil, and fresh apple scent that may appeal to a buck's feeding instinct. A user 305 may use the sling shot to strategically place the different device 100 types about the environment 300, 400 in order to minimize the amount of scent transferred from the user 305 to the environment 300, 400. A user 305 may use at least one device 100 designed to attract certain wildlife 405 and at least one device 100 designed to repel certain wildlife 405. For instance, a user 305 may have a plurality of devices 100 comprising powdered bone meal, fish oil, and blackberry extract that may appeal to a bear's feeding instinct. However, the blackberry extract may also appeal to the feeding instinct of other wildlife 405, so the user 305 may also use a device 100 comprising a gel-based bear gland lure and a biodegradable polymer impregnated with the bear gland lure to appeal to the bear's mating instinct while sending a warning to other wildlife 405 that a predator is in the area.

FIG. 5 provides a flow chart 500 illustrating certain, preferred method steps that may be used to carry out the process of distributing devices 100 within an environment 300, 400. Step 505 indicates the beginning of the method. During step 510, a user 305 may acquire devices 100 to use in an environment 300, 400. Once obtained, the user 305 may determine which devices 100 they would like to use in the environment 300, 400 during step 515. Based on the results of the determination step, the user 305 may take an action during step 520. If the user 305 decides not to use any of the devices 100 in an environment 300, 400, the method may proceed to the termination step 540. If the user 305 decides they do need to use some of the acquired devices 100, the user 305 may obtain a distribution tool during step 525. Distribution tools that may be used to distribute devices 100 within an environment 300, 400 include, but are not limited to slings, slingshots, launch tubes, gas power tubes, etc. Once the user 305 has obtained the distribution tool, the user 305 may determine a target during step 530 and subsequently use the distribution tool to distribute devices 100 to the target during step 535. Once the user 305 has distributed the devices 100, the method may proceed to the terminate method step 540.

FIG. 6 provides a flow chart 600 illustrating certain, preferred method steps that may be used to carry out the process of customizing devices 100 using at least one wildlife attractant 102. Step 605 indicates the beginning of the method. During step 610, a user 305 may obtain a device 100 having at least one bung 112. Once the device 100 having the at least one bung 112 has been acquired, the user 305 may obtain a syringe during step 615. The user 305 may then determine what at least one wildlife attractant 102 to inject into the device 100 during step 620. The user 305 may then acquire the at least one wildlife attractant 102 during step 625. Once the user 305 has obtained the at least one wildlife attractant 102, the user 305 may fill the syringe with the at least one wildlife attractant 102 during step 630. The user 305 may then use the filled syringe to fill the compartment of the plurality of compartments 110, 115, 120, 125 of the device 100 via the at least one bung 112 during step 635. Once filled, the user 305 may determine whether another compartment within the plurality of compartment 110, 115, 120, 125 needs to be filled using the wildlife attractant 102 during step 640. Based on the results of the determination, the user 305 may take an action during step 645. If the user 305 determines that more compartments of the plurality of compartments 110, 115, 120, 125 need to be filled with the wildlife attractant 102, the user 305 may proceed to step 625. If the user 305 determines that no more compartments of the device 100 need to be filled with the wildlife attractant 102, the method may proceed to the terminate method step 650.

Although the systems and processes of the present disclosure have been discussed for use within the hunting field, one of skill in the art will appreciate that the inventive subject matter disclosed herein may be utilized in other fields or for other applications in which multi-lured devices may be used. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results unless otherwise stated. It will be readily understood to those skilled in the art that various other changes in the details, materials, and arrangements of the parts and process stages which have been described and illustrated in order to explain the nature of this inventive subject matter can be made without departing from the principles and scope of the inventive subject matter.

What is claimed is:

1. A device for attracting wildlife comprising:
a wildlife attractant,
a shell comprising:
at least one barrier,
a plurality of compartments formed from said at least one barrier,
wherein said plurality of compartments hold said wildlife attractant,
wherein said wildlife attractant is separated by said plurality of compartments, and
wherein said shell at least partially breaks upon contact with a target.

2. The device of claim 1, wherein a first compartment of said plurality of compartments is at least partially surrounded by a second compartment of said plurality of compartments.

3. The device of claim 2, wherein said second compartment of said plurality of compartments is at least partially surrounded by a third compartment of said plurality of compartments.

4. The device of claim 1, wherein said shell comprises a rigid material.

5. The device of claim 4, wherein said shell further comprises a plurality of vents that allow said wildlife attractant to permeate to an environment.

6. The device of claim 1, wherein said shell comprises a soft material.

7. The device of claim 6, wherein said at least one barrier is at least semi-permeable to allow said wildlife attractant to permeate to an environment.

8. The device of claim 1, further comprising a bung that allows a user to inject said shell with said wildlife attractant.

9. The device of claim 1, wherein said wildlife attractant comprises at least one of pheromones, urine, vegetable extracts, and fruit extracts.

10. The device of claim 1, further comprising a biodegradable material,
wherein said biodegradable material is saturated with said wildlife attractant,
wherein said biodegradable material saturated with said wildlife attractant is held within said compartments.

11. A device for attracting wildlife comprising:
a wildlife attractant,
a shell comprising:
at least one rigid barrier,
a plurality of compartments formed from said at least one rigid barrier,
wherein said plurality of compartments hold said wildlife attractant,
wherein said wildlife attractant held within said plurality of compartments is divided by said plurality of compartments,
a bung designed to accept a syringe,
wherein a user may use said syringe to inject at least one of said plurality of compartments with said wildlife attractant via said bung, and
wherein said shell at least partially breaks upon contact with a target.

12. The device of claim 11, wherein a first compartment of said plurality of compartments is at least partially surrounded by a second compartment of said plurality of compartments.

13. The device of claim 12, wherein said second compartment of said plurality of compartments is at least partially surrounded by a third compartment of said plurality of compartments.

14. The device of claim 11, wherein said wildlife attractant comprises at least one of pheromones, urine, vegetable extracts, and fruit extracts.

15. The device of claim 11, further comprising a biodegradable material,
wherein said biodegradable material is saturated with said wildlife attractant,
wherein said biodegradable material saturated with said wildlife attractant is held within said compartments.

16. The device of claim 11, wherein said shell further comprises at least one soft barrier.

17. A device for attracting wildlife comprising:
a wildlife attractant,
a shell comprising:
an outer barrier,
wherein said outer barrier comprises an exterior surface and interior surface,
a plurality of compartments coupled to said interior surface of said outer barrier,
wherein a first compartment of said plurality of compartments is at least partially surrounded by a second compartment of said plurality of compartments
wherein said second compartment of said plurality of compartments is at least partially surrounded by a third compartment of said plurality of compartments,
wherein said plurality of compartments hold said wildlife attractant,
wherein said wildlife attractant is separated by said plurality of compartments, and
wherein said shell at least partially breaks upon contact with a target.

18. The device of claim 17, wherein said wildlife attractant comprises at least one of pheromones, urine, vegetable extracts, and fruit extracts.

19. The device of claim 17, further comprising a biodegradable material,
wherein said biodegradable material is saturated with said wildlife attractant,
wherein said biodegradable material saturated with said wildlife attractant is held within said compartments.

20. The device of claim 17, wherein said shell comprises polyvinyl acetate.
